(19) United States
(12) Patent Application Publication
(10) Pub. No.: US 2008/0070496 A1
(43) Pub. Date: Mar. 20, 2008

(54) Cell phone live redundancy data back-up system

(76) Inventor: Luke Jackson, Brooklyn, NY (US)

Correspondence Address: Donald W. Meeker;Patent Agent, 924 East Ocean Front #E, Newport Beach, CA, 92661, US

(21) Appl. No.: 11/524,179

(22) Filed: Sep. 20, 2006

(51) Int. Cl. H04H 1/00

(52) U.S. Cl. 455/3.03

(57) ABSTRACT

A remote cell phone back-up system which provides constant real-time redundant automatic back-up storage of all information contained in the cell phone at the wireless service provider and/or at a modular unit in a user's home or office. The remote cell phone back-up system automatically stores voice messages, missed calls, text messages, ring tones, phone numbers, email addresses, photographs, music and all data normally stored within the cell phone. The data may be accessed by phone or Internet connection.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to wireless phones and particularly to a remote cell phone back-up system which provides constant real-time redundant automatic back-up storage of all in formation contained in the cell phone at the wireless service provider and/or at a modular unit in a user's home or office, which automatically stores voice messages, missed calls, text messages, ring tones, phone numbers and all data normally stored within the cell phone, said data may be accessed by phone or Internet connection.

2. Description of Related Art Including Information Disclosed Under 37 CFR 1.97 and 1.98

With increasing dependence upon portable digital phones or cell phones, users will require not only one but several backup systems. It is not enough to merely save one's static information from permanent loss. One must also be able to stay connected in times of emergency or even just times of inconvenience. Information security has become an increasingly important consideration for most users and in not much time will become a primary expectation.

At present, when a cell phone is lost, all of the information stored in the cell phone is lost. Furthermore, until it is replaced, all voice messages, text messages, missed calls, or any other information that is normally stored on the cell phone is lost. The same problems exist temporarily when the battery runs down and the cell phone is temporarily unusable or when the cell phone is forgetfully left somewhere. If information is accidentally deleted from the cell phone, that is also lost with prior art systems.

Already there are prior art patents for devices which were specifically developed to backup information kept on a cell phone but either they require time and energy on the part of the consumer or they are dependant upon the consumer already having a computer and Internet connection and none of them enable ‘live redundancy’. Other products can back up static information readily enough but once the information is backed up and the user's handset is lost or stolen or damaged, that information remains inert and is essentially inaccessible until such time as the user obtains a new phone. Even in the cases where the products allow for access or even remote access, the one thing that is lost with the loss of a handset is ‘connectivity’: the ability to communicate with the world and to receive communications from the World.

Prior art systems require that a user input information to be stored and do not automatically store all information that goes into the cell phone.

Prior art U.S. Pat. No. 6,693,996, issued Feb. 17, 2004 to Mansfield, is for a system and method for data backup in a home network telephone system and method are provided for backing up user data. The system comprises at least one endpoint to transceive telephone communications. The endpoints can be devices such as telephones or fax machines, for example. The system also comprises a gateway to service and transceive telephone communication with the endpoints. The gateway has a memory to store a copy of user data associated with each endpoint. The gateway stores user data such as telephone directories, calling line ID (CLID) lists, call-logs, and user preferences for organizing the stored data. The gateway can supply the endpoints with an initial start-up configuration of user data, or re-supply an endpoint in response to the endpoint losing the copy of the user data stored in its local memory. Each endpoint receives the user data from the gateway and stores a copy of the user data in a local memory. Conversely, the endpoint has a user interface to generate user data and store the user data in local memory, and the gateway stores a copy of the user data generated by the endpoint in the gateway memory. More specifically, the gateway uses a control channel to receive a copy of the user data from an endpoint, and sends an acknowledgement to the endpoint that the user data has been received. When an endpoint modifies the user data, the control channel is used to send a copy of the modified user data to the gateway. Likewise, the endpoint uses a control channel to request user data from the gateway, in the event of battery failure, for example.

Prior art U.S. Patent Application #20020124057, published Sep. 5, 2002 by Besprosvan, is for a unified communications system that promotes communications using an Internet protocol communications platform that receives telephone, fax, e-mail, and documentary information to aggregate that information for access at a single location by any of various devices controlled by a person to whom the communications are directed. The unified communications system employs an IMAP4 message store for e-mail, fax, voice mail, and document files and can access LDAP-compatible databases for user information (e.g., address books). Subscribers to a unified communications service powered by the unified communications system can access messages by telephone; through a standard Web browser; through a wireless device, leveraging WAP to read and reply to messages and SMS for notifications; and, additionally, via Internet phones and other Internet Access Devices (IADs). Users can also store and access files on network databases and folders via the Web browser interface.

Prior art U.S. Patent Application #20020156921, published Oct. 24, 2002 by Dutta, describes an automatic backup of wireless mobile device data onto a gateway server while the device is idle. A method, system, and computer program product for backing up data from a wireless device onto a server via a network is provided. In one embodiment, a backup server, responsive to a determination that data from a wireless device should be backed up, initiates a backup process. The backup process may be initiating, for example, by pushing a request to the wireless client via a proxy/gateway server requesting that the client transmit data to be backed up to the backup server. A determination as to when to backup may be made, for example, in response to an indication that the wireless device has been powered on or in response to a determination that a predetermined amount of time has elapsed since the last backup was performed. The backup server then receives the data from the wireless device and stores the data on a storage device connected to the network for later retrieval such that if the wireless device loses its data, the data can be retrieved from the backup server and reloaded onto the wireless device. The backed up data may be, for example, phone lists, calendars, address lists, or notes.

Prior art U.S. Patent Application #20040264655, published Dec. 30, 2004 by Levine, illustrates a voice information storage and retrieval system and method and systems for allowing a telecommunications services subscriber to call a voice information application from a wireline or wireless telephone to allow the subscriber to record and save voice information and access, review and modify previously stored information such as subscriber contacts information, emergency telephone directories, business information, and the like. Information may be stored, accessed and modified by the subscriber via the voice information application by placing a voice telephone call from the subscriber to the voice information application or by contacting the voice information application via a distributed computing environment such as the Internet.

Prior art U.S. Patent Application #20040116155, published Jun. 17, 2004 by Aisenberg, shows a cellular telephone back up and media system that is structured for use with a cellular telephone of the type having an input structure and an internal memory on which a quantity of personal data is maintained. The back up and media system includes a memory module which contains a quantity of information and an external transfer module communicatively connected with the cellular telephone and defining an interface via which the memory module is communicatively connected with the internal memory of the cellular telephone. Transferring programming is further provided and is structured to direct the transfer of the personal information from the cellular telephone to the memory module as well as the transfer of information from the memory module to the internal memory of the cellular telephone.

Prior art U.S. Patent Application #20040153884, published Aug. 5, 2004 by Fields, claims a remote, automatic data service for wireless communications. An instruction set system (network) is provided for communication devices and other similar electronic devices, both wireless and non-wireless devices that provides a process and means for storing and recalling information, and for coordinating data stored on one of these devices with other digital storage means such as personal computers. The instruction set system (network) provides a mean to enable redundant storage and backup for data stored on these devices that is simple, automatic and requires as little user intervention/interface as possible, by way of employment of specific set of software instructions stored on a semiconductor chip or chip set executable on the dedicated microprocessors controlling communication devices that allow “wireless data acquisition” through the use of both currently available and futuristic wireless networks.

Prior art U.S. Patent Application #20050191998, published Sep. 1, 2005 by Onyon, claims a system for backing up data on a wireless telephone having a data store containing a user's personal information. A method and application are provided to ensure that information saved on a wireless phone, and the effort spent to ensure that information is entered and correct, are not lost if the phone itself is lost or damaged.

Prior art U.S. Patent Application #20050137983, published Jun. 23, 2005 by Bells, discloses a method and systems for handling a plurality of digital assets on a mobile device, wherein backups of the plurality of digital assets are created so as conform to digital rights management issues. Encrypted versions and/or links of the plurality of digital assets may be stored so that the mobile device or other electronic devices may access the backups.

Prior art U.S. Patent Application #20040235523, published Nov. 25, 2004 by Schrire, indicates a system for replicating the data of a mobile station. The data storage system is suitable for storing data in the SIM card of a mobile station is. On amending the data, an SMS or Internet message containing the amended data is transmitted to a remote data storage system for storage.

Prior art U.S. Patent Application #20050215236, published Sep. 29, 2005 by Myka, puts forth a method and system for delivering the archived personal content of mobile users and/or material selected on the basis of the archived personal content. At least one remote data repository is connected to the telecommunications system, storing therein information including personal content including data objects and/or information extracted from the objects. At least one of the repositories is assigned for each mobile terminal. Further, external data is stored somewhere in the network. Items of data are retrieved from the remote data repository, the items including an object and/or information extracted from an object. Then at least one predetermined criterion is read, the criterion defining a relationship between the retrieved, data and the external data. If the relationship fulfills a predetermined condition, data to be delivered to the mobile terminal is selected and then delivered to the mobile terminal.

Prior art U.S. Patent Application #20050120050, published Jun. 2, 2005 by Myka, concerns enhanced storage of personal content in the context of a mobile communications system and more specifically to archiving personal content of mobile users and for providing this content to mobile users in the most flexible and personalized ways. The core of the invention is how personal content acquired by the user may be further enhanced and stored in a safe box-like remote repository for future purposes. At least one remote data repository is assigned for the use of mobile terminals. Personal content is acquired and stored in the mobile terminal. Selected personal content is then transferred between the storage means and the remote data repository through the telecommunications system, the means to include predetermined criteria, the fulfillment of which initiates the transfer. The content refers here to any multimedia data, including e-mails, text messages, images, audio files, calendar entries, log information, and e-commerce data. The invention relates to acquiring personal content on a mobile terminal, storing it in a remote repository, and retrieving it from the remote repository.

Prior art U.S. Patent Application #20030022677, published Jan. 30, 2003 by Piikivi, shows a method for transporting data which comprises generation of a data entity in data storage means. The data entity is provided with further information. The data entity is then transported from the storage means to an interface means via a first communication media. Said further information is studied at the interface means for determining a user equipment to which data shall be transmitted from the interface means. Data is then transported from the interface means to said user equipment based on said information via a second communication media.

Prior art U.S. Patent Application #20030157960, published Aug. 21, 2003 by Kennedy, describes a system and a method for remotely storing information from portable electronics using a multi-point wireless link. The method and system involves a Bluetooth-enabled camera that communicates to a 3G cellular telephone via a Bluetooth wireless link, the telephone then uses the 3G wireless link to connect to a remote storage device via the Internet. Using this concept, the internal memory of the portable device is used as a buffer memory without needing to be in the vicinity of a computer because the cellular telephone can act as a go between from the portable device to the storage space via the Internet.

What is needed is a completely redundant automatic backup system of all of the information normally stored or received on the cell phone to insure continuous storage of information accessible anytime via the Internet or any telephone using a coded access system.

### BRIEF SUMMARY OF THE INVENTION

An object of the present invention is to provide a completely redundant automatic backup system of all of the information normally stored or received on the cell phone to insure continuous storage of information accessible anytime via the Internet or any telephone using a coded access system.

Another object of the present invention is to provide a completely redundant automatic backup system of all of the information normally stored or received on the cell phone wherein the automatic redundant storage of all information takes place at a central location for a large number of users with separate coded access accounts.

One more object of the present invention is to provide a completely redundant automatic backup system of all of the information normally stored or received on the cell phone wherein the automatic redundant storage of all information takes place at a user module in a user's home or office.

An additional object of the present invention is to provide a completely redundant automatic backup system of all of the information normally stored or received on the cell phone wherein the automatic redundant storage of all information takes place both at a central location for a large number of users with separate coded access accounts and at a user module in a user's home or office.

In brief, the present invention provides a data storage file at the cellular telephone service provider company and/or at a modular unit at a user's home or office, which stores any information that is also normally stored on the cell phone automatically as a redundant backup, so that if the cell phone is lost or broken or the cell phone is beyond repair or the battery runs down or the cell phone is forgotten or left somewhere by mistake, anything stored on it is not lost and also any information coming into the cell phone is not lost not matter how long it takes to replace the cell phone. The present invention allows messages or calls or anything else that is transmitted to your cell phone and normally stored on your cell phone to be saved for access by phone or Internet at a code accessed remote storage device. The data storage file would be accessible by phone or Internet connection with a password or other security system, so the information can be accessed at any time.

The present invention is a solution to the above stated cell phone problems. There are three alternate embodiments of the present system:
1. A Centralized Remote Backup System (C.R.B.S.) where the automatic redundant storage of all information takes place at a central location for a large number of users with separate coded access accounts;
2. An Individualized Remote Backup System (I.R.B.S.) where the automatic redundant storage of all information takes place at a user module in a user's home or office; and
3. A Joined Remote Backup System (J.R.B.S.) where the automatic redundant storage of all information takes place both at a central location for a large number of users with separate coded access accounts and at a user module in a user's home or office.

An advantage of the present invention is that it provides a complete backup for all of the cell phone functions.

Another advantage of the present invention is that it may be accessed by phone or Internet.

A further advantage of the present invention is that the back up is in real-time simultaneous with the user's cellular telephone usage.

One more advantage of the present invention is that the cell phone may be backed up at a service provider's central storage.

An additional advantage of the present invention is that the cell phone may be backed up at a module in the user's possession.

A further advantage of the present invention is that the cell phone may be backed up at a service provider's central storage and at a module in the user's home or business concurrently.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a diagrammatic view of the centralized remote backup system (CRBS) of the present invention with the cellular telephone available for use;

FIG. 2 is a diagrammatic view of the centralized remote backup system (CRBS) of the present invention with the cellular telephone not available for use;

FIG. 3 is a diagrammatic view of the individualized remote backup system (IRBS) of the present invention with the cellular telephone available for use;

FIG. 4 is a diagrammatic view of the individualized remote backup system (IRBS) of the present invention with the cellular telephone not available for use;

FIG. 5 is a diagrammatic view of the joined remote backup system (JRBS) of the present invention with the cellular telephone available for use;

FIG. 6 is a diagrammatic view of the joined remote backup system (JRBS) of the present invention with the cellular telephone not available for use;

FIG. 7 is a diagrammatic view of a flow chart showing a variety of backup activities that are possible with the present invention.

### DETAILED DESCRIPTION OF THE INVENTION

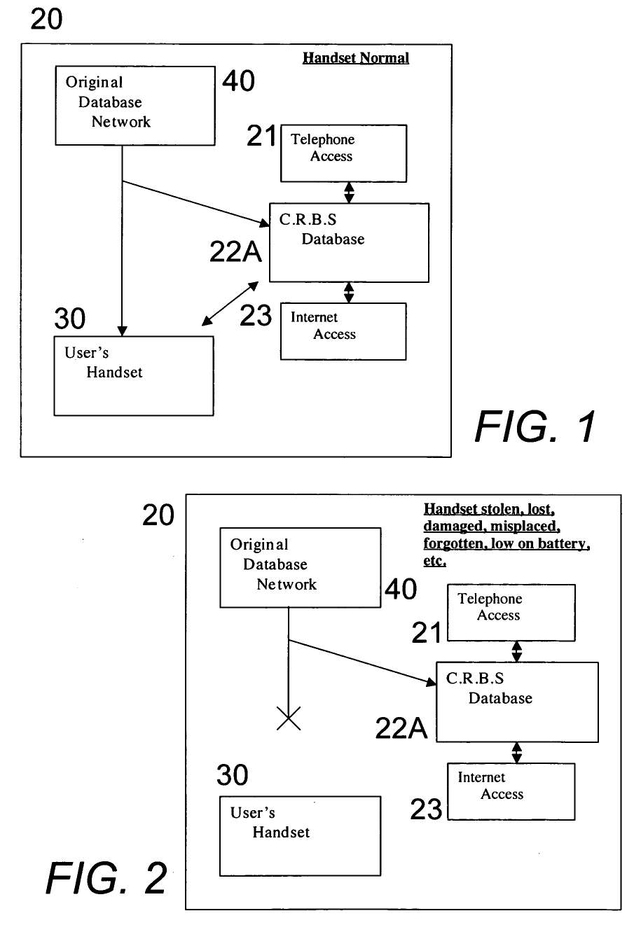

In FIGS. 1-7, a cellular telephone live redundancy or active back-up system 20 provides constant real-time redundant automatic back-up of all information contained in the cellular telephone 30 at a remote storage location in an electronic storage and transmission device 22A and 22B.

The cellular telephone live redundancy or active back-up system 20 comprises an electronic storage and transmission device 22A and 22B at a secure location separate from a user's cellular telephone 30. The electronic storage and transmission device 22A and 22B comprises a means for automatically receiving all wireless signals sent to the user's cellular telephone 30 and all information stored in a user's cellular telephone 30 at variable, pre-determined intervals with the user's cellular telephone 30. The electronic storage and transmission device 22A and 22B also comprises a means for automatically storing all information sent to a user's cellular telephone 30 and stored in the user's cellular telephone 30 at variable, pre-determined intervals with the user's cellular telephone 30. The electronic storage and transmission device 22A and 22B further comprises a means for sending transmissions normally sent by a user's cellular telephone 30 to a cellular telephone service provider system 40 for communication with the global telephone communication network.

The electronic storage and transmission device 22A and 22B also has a programmed means for carrying out all activities of the electronic storage and transmission device 22A and 22B automatically in real-time, which comprises software and hardware communicating with the electronic storage device 22A and 22B.

The electronic storage and transmission device 22A and 22B further comprises a security protocol to allow coded access to the electronic storage device 22A and 22B by a user employing the user's cellular telephone 30, an alternate telephone 21, and a computer modem via the Internet 23 so that a user can access all information normally accessed via a user's cellular telephone 30 and perform all functions normally performed by a user's cellular telephone 30 using a telephone connection 21 and an Internet connection 23 without the user's cellular telephone 30 to provide a constant redundant automatic cellular telephone back-up system 20 at a secure location separate from the cellular telephone 30 so that a user maintains all cellular telephone 30 interactions even when the user's cellular telephone 30 is not usable, as shown in FIGS. 2, 4 and 6.

The cellular telephone live redundancy or active back-up system 20 further comprises a programmable means for blocking use of the user's cellular telephone 30 in the event of loss of the cellular telephone 30 by a user to prevent unauthorized use of the cellular telephone 30. The means for blocking comprises a coded means for signaling the user's cellular telephone service provider 40 to send transmissions only to the electronic storage device 22A and 22B and not to the user's cellular telephone 30 and a means for signaling the user's cellular telephone service provider 40 to receive only transmissions from the electronic storage device 22A and 22B and not from the user's cellular telephone 30 and in the event that the handset is recovered, the cellular telephone can be reconnected to the service provider network.

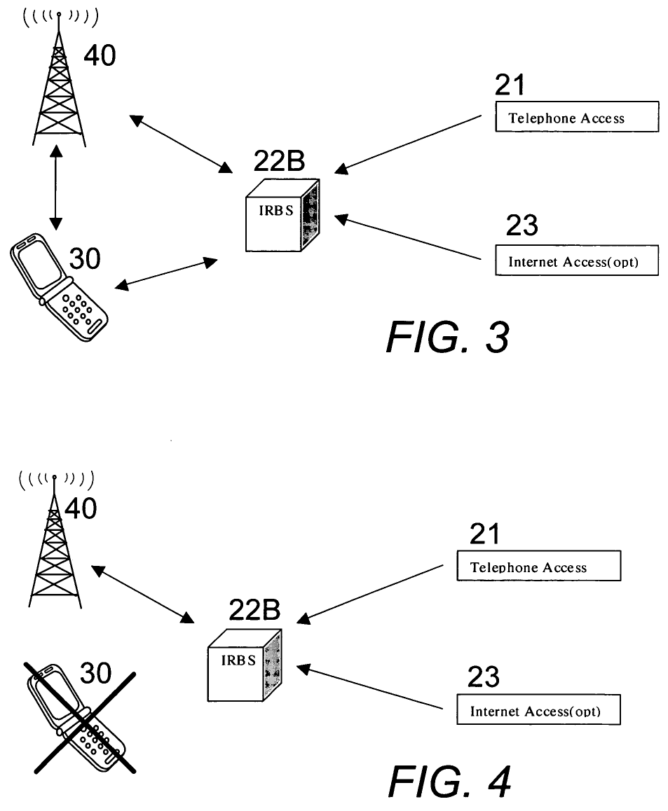

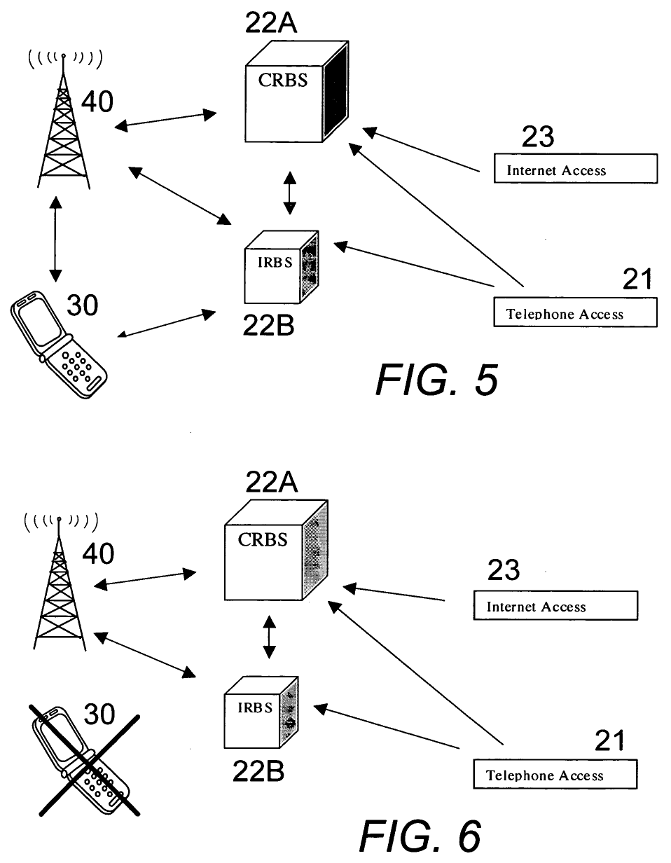

The electronic storage device 22A may be located at a user's cellular telephone service provider location 40, as shown in FIGS. 1 and 2. The electronic storage device 22B may alternately be located at a user's location, as shown in FIGS. 3 and 4. For added redundancy and security, the system 20 may comprise two electronic storage devices 22A and 22B, a first storage device 22A one located at a user's cellular telephone service provider's location 40 and the second storage device 22B located at a user's location, as shown in FIGS. 5 and 6.

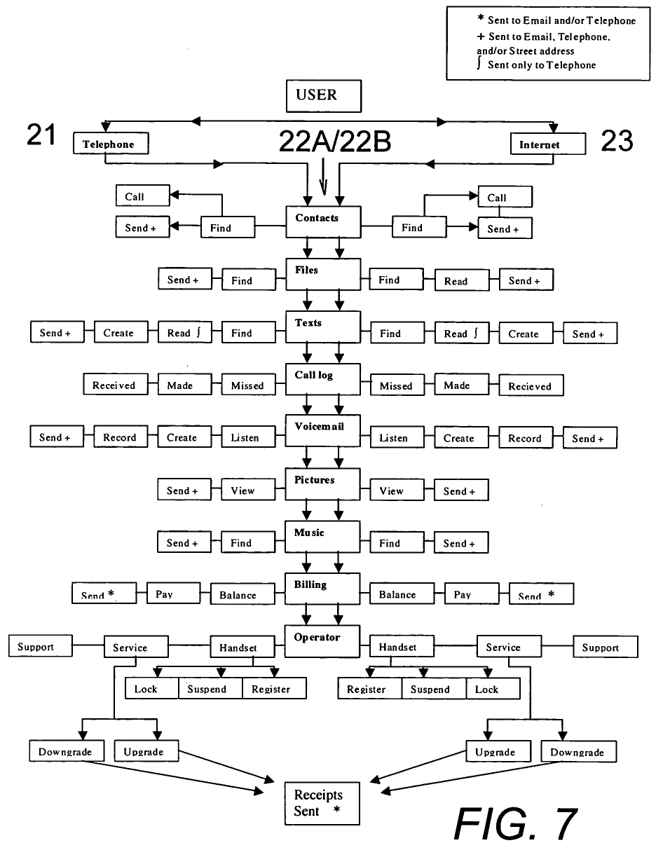

In FIG. 7, a variety of backup activities are shown that are possible with the present invention 20, which include using the electronic storage and transmission device 22A and 22B for: finding, sending and calling contacts; finding, reading, and sending files; finding, creating, reading, and sending texts; accessing missed, made, and received call logs; recording, creating, sending, and listening to voice mail; sending and viewing digital movies, photographs or pictures; finding, sending, receiving and listening to music; sending and receiving billing information, making payments and accessing balances of the user's account; accessing the operator for upgrades, downgrades, support and service; and blocking unauthorized blocking use of the user's cellular telephone 30 in the event of loss of the cellular telephone 30.

In use, the cell phone back-up system 20 provides constant real-time redundant automatic back-up storage of all information contained in the cell phone 30 at a remote storage location 22A and 22B. The cellular telephone backup system 20 may be accessed from the user's handset 30, a different telephone 21, or the Internet 23 via an Internet telephony system such as VoIP. If the user experiences loss of cellular telephone usage, due to theft, loss or damaged to the cell phone 30, the ‘live redundancy’ of the system 20 allows the user to do everything their cellular telephone handset 30 is capable of without being dependent upon the actual cellular telephone handset 30. The user will be able to place calls and text messages remotely, (among other things), charging their account with their service provider 40 and not the alternate telephone 21 or Internet service 23 from which those calls are made. If the user's cell phone 30 is lost, the information on the cellular telephone handset 30 may be rendered inaccessible by using a blocking code for signaling the user's cellular telephone service provider 40 to send transmissions only to the electronic storage device 22A and 22B and not to the user's cellular telephone 30 and for signaling the user's cellular telephone service provider 40 to receive only transmissions from the electronic storage device 22A and 22B and not from the user's cellular telephone 30.

The cell phone back-up system 20 may have a remote storage location 22A at a wireless service provider 40 and/or at a modular unit 22B in a user's home or office.

In FIGS. 1 and 2, the centralized remote backup system (CRBS) 22A would essentially be a hub located in a building or several buildings in which, subsequent to having received permission from the user, an instruction is issued to either the software or hardware of the service provider 40 or to the user's cellular telephone handset 30. Once the instruction is sent, all the activity on that user's cellular telephone handset 30 would be copied and diverted to the central hub 22A so that in the event of cellular telephone handset 30 loss, theft, damage, misplacement, or loss of power, the user would still be able to make calls, check their call log to see if they've missed any calls, retrieve contact details, (phone number, email, address, etc., etc.), check voice messages, receive text messages, block the handset, transfer files to an email address, etc., etc.. In the case of inability to use the user's cellular telephone 30 for any reason the user would either:
A. call a toll free number from any phone 21, enter their phone number, enter a pin, or whatever security protocol is necessary, and then choose a function which they wish to use; or
B. Using a computer modem or other Internet access means 23, go to the website of the CRBS service provider, enter a username and password, and then choose a function which they wish to use.

In FIGS. 3 and 4, the individualized remote backup system (IRBS) 22B is a system wherein an item consisting of the necessary working parts of a cellular telephone 30, i.e. transceiver/receiver, power module, memory store (flash or hard disk), would shadow the activity of the user's cellular telephone handset 30 by essentially being setup as a second line on the user's service provider account, and in the case of loss, theft, damage, misplacement, or loss of power, enable all the same functions as CRBS 22A. The only real difference in function from CRBS 22A is that IRBS 22B would most likely only be accessible via telephone 21 and not Internet computer connection 23 although it could be accessible via the Internet computer connection 23 with a live Internet connection to the IRBS 22B. This would in effect be an advanced descendant of the home phone message machine where it would certainly record voice messages, but it would also track missed received and made calls, allow remote calling and text messaging, and basically do everything the user's primary cellular telephone handset 30 does only in absentia.

In FIGS. 5 and 6, the joined remote backup system (JRBS) is a system comprised of a flexible combination of a CRBS 22A and an IRBS 22B wherein the IRBS 22B would itself be backed up by the CRBS 22A, and vice versa, via the same instruction issued in CRBS 22A only issued twice this time with the duplicate information being sent to both, the CRBS hub 22A and the IRBS module 22B. The advantage to the JRBS would be added redundancy and security. For instance, if something were to happen to the user's IRBS module 22B then that information would be lost and the point of ever having gotten one would be lost with it. If something drastic were to happen to the building where the CRBS 22A was operated from and the CRBS 22A somehow encountered an unforeseen mishap, then again, the information would be lost if not secondarily backed up. The best solution is an integrated network (JRBS, shown in FIGS. 5 and 6) of these two backup systems 22A and 22B, wherein both systems 22A and 22B run as defined above yet are in constant communication ultimately affording the user a choice of access method and level of security, or degree of protection.

It is understood that the preceding description is given merely by way of illustration and not in limitation of the invention and that various modifications may be made thereto without departing from the spirit of the invention as claimed.

What is claimed is:

1. A cellular telephone back-up system which provides constant real-time redundant automatic back-up of all information contained in the cell phone at a remote storage location, the system comprising:
an electronic storage and transmission device at a secure location separate from a user's cellular telephone, the electronic storage and transmission device comprising a means for automatically receiving all wireless signals sent to the user's cellular telephone and all information stored in a user's cellular telephone at variable, pre-determined intervals with the user's cellular telephone; a means for automatically storing all information sent to a user's cellular telephone and stored in the user's cellular telephone at variable, predetermined intervals with the user's cellular telephone; a means for sending transmissions normally sent by a user's cellular telephone to a cellular telephone service provider system for communication with the global telephone communication network; a programmed means for carrying out all activities of the electronic storage and transmission device automatically in real time; a security protocol to allow coded access to the electronic storage device by a user employing the user's cellular telephone, an alternate telephone, and a computer modem via the Internet so that a user can access all information normally accessed via a user's cellular telephone and perform all functions normally performed by a user's cellular telephone using a telephone connection and an Internet connection without the user's cellular telephone to provide a constant redundant automatic cellular telephone back-up system at a secure location separate from the cellular telephone so that a user maintains all cellular telephone interactions even when the user's cellular telephone is not usable.

2. The system of claim 1 further comprising a programmable means for blocking use of the user's cellular telephone in the event of loss of the cellular telephone by a user to prevent unauthorized use of the cellular telephone, the means for blocking comprising a coded means for signaling the user's cellular telephone service provider to send transmissions only to the electronic storage device and not to the user's cellular telephone and a means for signaling the user's cellular telephone service provider to receive only transmissions from the electronic storage device and not from the user's cellular telephone and in the event that the handset is recovered, the cellular telephone can be reconnected to the service provider network.

3. The system of claim 1 wherein the programmed means for carrying out all activities of the electronic storage device automatically in real time comprises software and hardware communicating with the electronic storage device.

4. The system of claim 1 wherein the electronic storage device is located at a user's cellular telephone service provider location.

5. The system of claim 1 wherein the electronic storage device is located at a user's location.

6. The system of claim 1 wherein the system comprises two electronic storage devices, one located at a user's cellular telephone service provider's location and the other located at a user's location.
